(19) United States
(12) Patent Application Publication
(10) Pub. No.: US 2009/0082915 A1
(43) Pub. Date: Mar. 26, 2009

(54) APPARATUS FOR TRANSPORTING A LOAD

(75) Inventors: Cristiano Manzi, Genova (IT); Giuseppe Pizzoccheri, Piacenza (IT)

Correspondence Address: YOUNG & THOMPSON, 209 Madison Street, Suite 500, ALEXANDRIA, VA, 22314, US

(73) Assignee: C.V.S., S.P.A., Roveleto Di Cadeo (IT)

(21) Appl. No.: 12/067,938

(22) PCT Filed: May 17, 2006
(86) PCT No.: PCT/IB06/01287

§ 371 Date: Jul. 25, 2008

(30) Foreign Application Priority Data
Sep. 30, 2005 (IB) BO2005A000592

(51) Int. Cl. B60L 11/02

(52) U.S. Cl. 701/22; 180/65.21; 180/65.31

(57) ABSTRACT

An apparatus (10) for transporting a load, in particular for transporting a container, particularly of the gantry type, includes an electrical power user element (30a, 30b, 30c, 30d, 32a) which has a respective control element (30′a, 30′b, 30′c, 30′d, 32′a), and an element (34, 36) for supplying electrical power to the user element (30a, 30b, 30c, 30d, 32a). The element for supplying electrical power includes at least an internal combustion engine (34) and an element (36) for transforming the mechanical power generated by the internal combustion engine into electrical power to be supplied to the user element. Advantageously, there are elements which allow a change in the operating speed of the internal combustion engine (34) according to the power required by the user element.

### TECHNICAL FIELD

The present invention relates to an apparatus for transporting a load.

In particular, the present apparatus consists of an apparatus for transporting a container, and in particular it consists of a so-called “gantry” type apparatus.

### BACKGROUND ART

Apparatuses for transporting a container are known, particularly of the gantry type, which comprise a framework supported on suitable wheels for moving the apparatus along a desired path, and supporting means for picking up the container, which are mobile at least between a container pick up or release position and a container transport position.

These prior art apparatuses have drive means for the apparatus movement wheels, comprising respective electric motors, and drive means for the container pick up means, comprising one or more electric motors.

In the known way, the electric motors for driving the wheels and the container pick up means are electrically powered by suitable electricity supply means, comprising an internal combustion engine and means for transforming the mechanical power generated by the internal combustion, engine into electrical power to be supplied to the electric drive motors. In the traditional way, in the sector these transformation means consist of an alternator.

Therefore, in the sector the speed of rotation of the alternator is practically constant, whilst the power used by the electric motors may vary according to specific requirements, thanks to the control of corresponding motor control circuits.

This means that, according to this way of operating, the internal combustion engine is operated at constant speeds, to allow the alternator to operate at a constant speed, even if the apparatus is operating in conditions which do not require such a level of power. This leads to excessive fuel consumption for companies which use such transport apparatuses.

This invention provides an apparatus for transporting a load, in particular for transporting a container, particularly of the gantry type, comprising electrical power user means which have respective control means, and means for supplying electrical power to the user means, in which the means for supplying electrical power comprise at least an internal combustion engine and means for transforming the mechanical power generated by the internal combustion engine into electrical power to be supplied to the user means; characterised in that there are means for controlling the electrical power supplied to the user means, designed to allow a variation in the operating speed and the electrical power emitted by the transformation means according to the power required by the user means.

This allows a variable power supply speed for the internal combustion engine, saving fuel compared with the prior art.

According to another aspect, the invention provides an apparatus for transporting a load, in particular for transporting a container, particularly of the gantry type, comprising electrical power user means which have respective control means, and means for supplying electrical power to the user means, in which the means for supplying electrical power comprise at least an internal combustion engine and means for transforming the mechanical power generated by the internal combustion engine into electrical power to be supplied to the user means; characterised in that there are means acting on the internal combustion engine output shaft, using electricity produced by the user means.

In this way, the energy produced by the user means can be used to achieve corresponding fuel savings.

According to yet another aspect, there are means for controlling the transformation means, designed to allow inverse operation of the transformation means as an electric motor acting on the internal combustion engine.

This provides a simple, basic circuit configuration.

### BRIEF DESCRIPTION OF THE DRAWINGS

The technical characteristics of the apparatus are apparent from the detailed description which follows, with reference to the accompanying drawings which illustrate a preferred, non-limiting embodiment of the invention, and in which:

FIG. 1 is a perspective view of an apparatus fitted with the drive system in accordance with the present invention;

FIG. 2 is a general block diagram illustrating, in particular, the power control circuit in a first preferred embodiment of an apparatus in accordance with the present invention;

FIG. 3 is a general block diagram illustrating, in particular, the power control circuit in a second preferred embodiment of the apparatus in accordance with the present invention.

### DETAILED DESCRIPTION OF THE PREFERRED EMBODIMENTS OF THE INVENTION

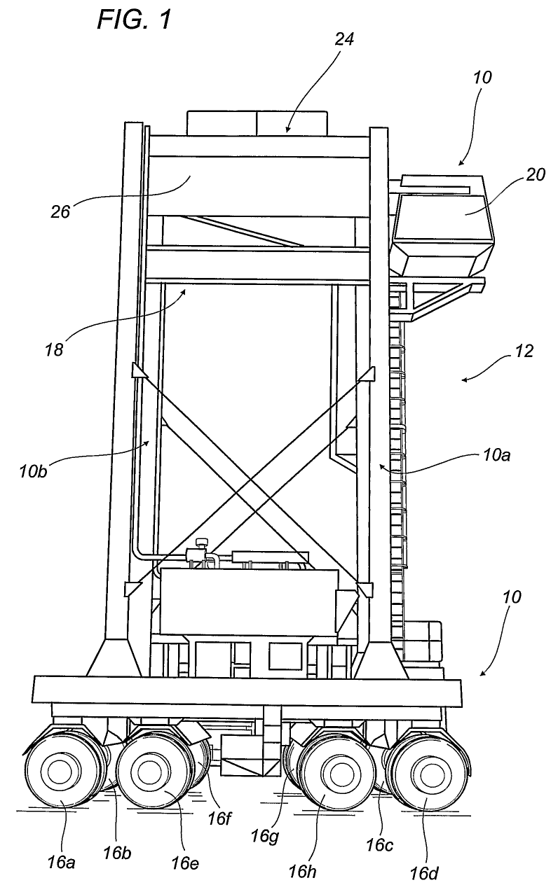

A preferred embodiment 10 of an apparatus for transporting a load, in particular for transporting a container, is schematically illustrated in FIG. 1.

The apparatus 10, of the gantry type, comprises a support framework, labelled 12 as a whole, which forms a first and a second side 10a, 10b of the apparatus, between which the load or container is carried, in particular suitably lifted and lowered.

The apparatus also comprises user means for electrical power suitably generated, as described in more detail below.

In the apparatus, the framework is supported by suitable means which allow the apparatus to be moved along a desired path.

As illustrated, said movement means consist of a plurality of wheels resting on the ground. In particular, they consist of eight wheels 16a, 16b, 16c, 16d, 16e, 16f, 16g, 16h, comprising a respective rim and an outer tread element.

Of these wheels, the wheels 16a, 16b, 16c, 16d are suitably driven to draw the apparatus, respectively, forward and backward, according to linear or curved paths, so that the load can be transported from one zone to another at the work terminal, for example a port or railway yard, where the present apparatus is used.

As illustrated, the apparatus also comprises means 18 for picking up the load, the means 18 being vertically mobile between a lowered position, for example for picking up or releasing the load, and at least one lifted position, for example for transporting the load.

The load pick up means 18 are also usually mobile towards and away from an upper lifted position, which allows the positioning or pick up of a load on top of another container. There may also be other lifted operating positions.

In addition, there is an apparatus driver's or control position or cab 20 which, as illustrated, is supported by the framework, extending at the front and projecting from the framework.

As illustrated, in particular in FIG. 1, there are also means 24 for housing the apparatus drive means.

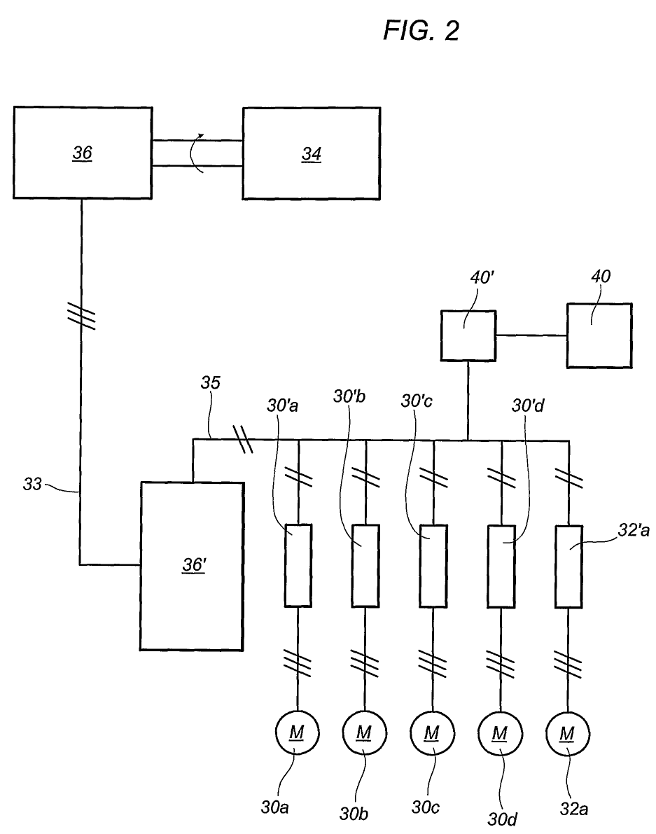

As illustrated in FIG. 2, the apparatus user means comprise means for driving the wheels 16a, 16b, 16c, 16d, 16e, 16f, 16g, 16h of the apparatus and consisting of electric motors 30a, 30b, 30c, 30d. In practice, only four of the eight wheels 16a, 16b, 16c, 16d, 16e, 16f, 16g, 16h are motor-driven.

For this purpose, there are control means 30′a, 30′b, 30′c, 30′d for the electric motors 30a, 30b, 30c, 30d, designed to vary the speed of the motors according to operating requirements and after suitable commands issued by the driver.

The apparatus user means also comprise drive means for the load pick up means 18, consisting of an electric motor 32a, with respective control means 32′a, also designed to vary the motor operating speed, to allow suitable pick up means 18 lifting or lowering. However, a greater number of load lifting and lowering electric motors may be imagined.

As illustrated particularly in FIG. 2, there are means 34, 36 for supplying electrical power to the user means, that is to say, to the drive means 30a, 30b, 30c, 30d of the movement means 16a, 16b, 16c, 16d and to the drive means 32a of the load pick up means 18.

These means for supplying electrical power comprise at least an internal combustion engine 34, with a mechanical power output shaft (not illustrated) and means 36 for transforming the mechanical power generated by the internal combustion engine into electrical power to be supplied to means 35 for electrical connection to the user means 30a, 30b, 30c, 30d, 32a.

The electrical transformation means 36 comprise a mechanical power input shaft, operatively connected to the output shaft of the internal combustion engine 34 so that it can rotate with the latter in both directions.

Advantageously, there are means 36′ for controlling the electrical power supplied to the user means, the control means 36′ being designed to allow a variation in the operating speed and electrical power emitted by the transformation means according to the power required, at that moment, by the user means 30a, 30b, 30c, 30d, 32a.

This allows a variable power supply speed for the internal combustion engine, saving fuel compared with the prior art.

In particular, the operating speed of the internal combustion engine 34 will be increased when there is an increase in the power required by the user means, whilst the operating speed of the internal combustion engine 34 will be reduced when there is a reduction in the power required by the user means.

Thus, the speed of the internal combustion engine may continually vary between a minimum speed and a maximum speed.

According to another advantageous aspect, there are means acting on the output shaft of the internal combustion engine 34, using electricity produced by the user means 30a, 30b, 30c, 30d, 32d.

In practice, the electricity available on the circuit downstream of the transformation means 36 is transformed into mechanical energy available on the shaft of the internal combustion engine 34.

Advantageously, but not exclusively, said mechanical energy available on the shaft of the internal combustion engine 34 is suitably used to slow the motion of the apparatus.

In particular, there are, advantageously, means 36′ for controlling the transformation means 36, designed to allow inverse operation of the transformation means 36, as an electric motor acting on the internal combustion engine 34, which it supplies with mechanical power.

The means 36 acting on the internal combustion engine 34 and the internal combustion engine 34 itself, therefore, operate using electricity produced by the drive means 30a, 30b, 30c, 30d of the movement means 16a, 16b, 16c, 16d and/or by the drive means 32a of the load pick up means 18.

In this way, for example, when the user devices no longer need to be supplied with electrical power, the primary internal combustion engine 34 can be slowed, which is very advantageous in terms of the amount of fuel the engine consumes.

As illustrated, the means 35 for electrical connection between the transformation means 36 and the user means comprise a supply line 35 shared by the drive means 30a, 30b, 30c, 30d of the movement means 16a, 16b, 16c, 16d and the drive means 32a of the load pick up means 18.

In practice, the control means 36′ operate on the transformation means to invert the operation of the latter according to the electrical power supplied to the connection means 35 by the user means.

In particular, the control means 36′ operate on the transformation means 36 to invert the operation of the latter when electrical power is supplied to the connection means 35 by the drive means 30′a, 30′b, 30′c, 30′d of the movement means.

In particular, the drive means 30′a, 30′b, 30′c, 30′d of the movement means supply electrical power to the transformation means 36 when the apparatus is slowed.

In particular, the control means 36′ operate on the transformation means to invert the operation of the latter when electrical power is supplied to the connection means 35 by the drive means 32′a of the load pick up means.

In particular, the drive means 32′a of the load pick up means supply electrical power to the transformation means 36 when the load is lowered.

In FIG. 2, the numeral 33 denotes the electrical connection between the transformation means 36 and the means 35 for connection to the user means.

The means 36′ for controlling the transformation means 36 are designed to increase or reduce the electrical power supplied to the connection line 35, in particular according to the requirements or demands of the drive means 30′a, 30′b, 30′c, 30′d and 32′a.

In FIG. 2, the numeral 40 denotes means which may be present for dispersal of the power not used by the user means and 40′ denotes respective control means. These dispersal means may consist of electrical heating elements which transform the electricity into heat. Advantageously, using the present circuit, these dispersal means 40 could be completely omitted, or it would be possible to use heating elements smaller than those used in the prior art apparatuses.

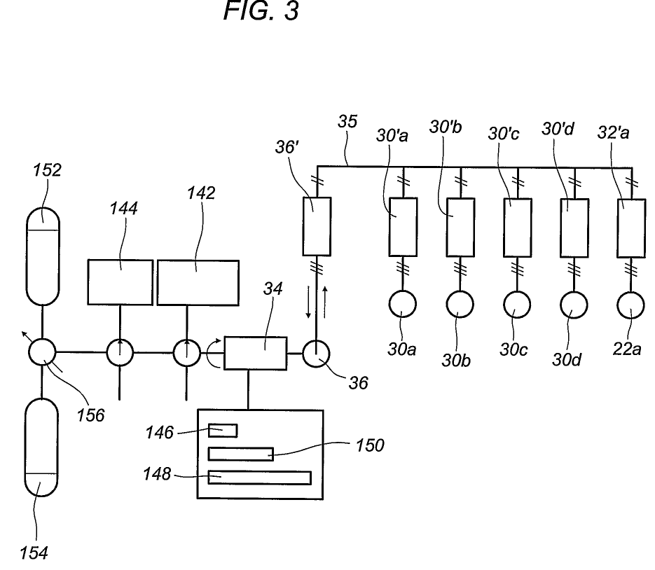

A second preferred embodiment of the apparatus in accordance with the present invention is illustrated in FIG. 3. The second embodiment of the apparatus is similar to the first embodiment previously described and for brevity and simplicity any components similar to those of the first embodiment are not described again in detail and are labelled with the same reference characters.

FIG. 3 shows how, in this second preferred embodiment, the energy recovered or returned from the user means is, advantageously, used to drive, by means of the internal combustion engine 34, a hydraulic distributor 142, the steering device 144, the engine fan 146, the driver's cab air conditioning unit 148 and the alternator for charging the electric batteries 150.

In this second preferred embodiment there are also, advantageously, energy storage means, comprising means for storing energy in a pressurised fluid.

In particular, there are first storage means, consisting of a specific accumulator, or tank 152 for containing the fluid, which is designed to contain a fluid at a high pressure. By way of example, said high pressure accumulator could contain fluid at a pressure of 200-300 bar.

There are also second storage means, consisting of a specific accumulator, or tank 154 for containing the fluid, which is designed to contain a fluid at a low pressure. By way of example, said low pressure accumulator could contain fluid at a pressure of 0-30 bar.

Moreover, the energy storage means comprise pumping means 156, connected to the internal combustion engine 34 and designed to transfer the fluid between the first storage means 152 and the second storage means 154.

In practice, during energy recovery from the user means, the pumping means compress a fluid from the low pressure storage means 154 into the high pressure storage means 152, whilst during use of the energy stored in the means 152, the pumping means 156 transfer the fluid, or hydraulic oil, from the high pressure accumulator 152 to the low pressure accumulator 154, obtaining mechanical energy which is, advantageously, used when the load is lifted and when the apparatus is accelerated. This gives a significant saving in terms of fuel for the present apparatus.

The invention described has evident industrial applications and can be modified and adapted without thereby departing from the scope of the inventive concept. Moreover, all details of the invention may be substituted by technically equivalent elements.

1. An apparatus (10) for transporting a load, in particular for transporting a container, particularly of the gantry type, comprising electrical power user means (30a, 30b, 30c, 30d, 32a) which have respective control means (30′a, 30′b, 30′c, 30′d, 32′a), and means (34, 36) for supplying electrical power to the user means (30a, 30b, 30c, 30d, 32a), wherein the means for supplying electrical power comprise at least an internal combustion engine (34) and means (36) for transforming the mechanical power generated by the internal combustion engine into electrical power to be supplied to the respective electric drive motor; the apparatus being characterised in that there are means (36′) for controlling the electrical power supplied to the user means, designed to allow a variation in the operating speed and the electrical power emitted by the transformation means (36) according to the power required by the user means (30a, 30b, 30c, 30d, 32a).

2. The apparatus according to claim 1, characterised in that there are means acting on the output shaft of the internal combustion engine (34), said means using electricity produced by the user means (30a, 30b, 30c, 30d, 32d).

3. The apparatus according to claim 1, characterised in that there are means (36′) for controlling the electrical transformation means (36), designed to allow inverse operation of the transformation means (36) as an electric motor acting on the internal combustion engine (34).

4. The apparatus according to claim 1, characterised in that it comprises means (16a, 16b, 16c, 16d) for moving the apparatus along a desired path and also characterised in that the user means comprise drive means (30a, 30b, 30c, 30d) for the apparatus movements means (16a, 16b, 16c, 16d) consisting at least of an electric motor with control means (30′a, 30′b, 30′c, 30′d).

5. The apparatus according to claim 1, characterised in that it comprises load pick up means (18) which are mobile at least between a load pick up or release position and a load transport position, and also being characterised in that the user means comprise drive means for the load pick up means (18) consisting of at least one electric motor (32a) with control means (32′a).

6. The apparatus according to claim 4, characterised in that the control means (36′) operate on the transformation means (36) to invert the operation of the latter, when electrical power is supplied by the drive means of the movement means.

7. The apparatus according to claim 6, characterised in that the drive means of the movement means supply electrical power to the transformation means when the apparatus is slowed.

8. The apparatus according claim 5, characterised in that the control means (36′) operate on the transformation means (36) to invert the operation of the latter, when electrical power is supplied by the drive means (32a) of the load pick up means.

9. The apparatus according to claim 8, characterised in that the drive means of the load pick up means supply electrical power to the transformation means when the load is lowered.

10. The apparatus according to claim 4, characterised in that the movement means consist of a plurality of wheels for moving the apparatus.

11. The apparatus according to claim 4, characterised in that it comprises a plurality of motors for driving the movement means.

12. The apparatus according to claim 1, characterised in that the speed of the internal combustion engine is continuously varied between a minimum speed and a maximum speed.

13. The apparatus according to claim 1, characterised in that energy produced by the user means is used to drive a hydraulic distributor.

14. The apparatus according to claim 1, characterised in that energy produced by the user means is used to drive a hydraulic distributor.

15. The apparatus according to claim 1, characterised in that energy produced by the user means is used to drive the steering wheel.

16. The apparatus according to claim 1, characterised in that energy produced by the user means is used to drive the engine fan.

17. The apparatus according to claim 1, characterised in that energy produced by the user means is used to drive the driver's cab air conditioning unit.

18. The apparatus according to claim 1, characterised in that energy produced by the user means is used to drive the alternator for charging electric batteries.

19. The apparatus according to claim 1, characterised in that it comprises energy storage means.

20. The apparatus according to claim 19, characterised in that the energy storage means comprise means for storing energy in a pressurised fluid.

21. The apparatus according to claim 20, characterised in that the means for storing energy in a pressurised fluid comprise first means for storage of the fluid (152).

22. The apparatus according to claim 21, characterised in that the first means for storage of the fluid (152) are designed to contain a fluid at a high pressure.

23. The apparatus according to claim 19, characterised in that means for storing energy in a pressurised fluid comprise second means for storing the fluid (154).

24. The apparatus according to claim 23, characterised in that the second means for storage of the fluid (154) are designed to contain a fluid at a low pressure.

25. The apparatus according to claim 19, characterised in that the energy storage means comprise pumping means (156) designed to transfer the fluid between the first and second storage means (152, 154).

26. The apparatus according to claim 19, characterised in that the energy stored in the storage means is used when the loads is lifted.

27. The apparatus according to claim 19, characterised in that the energy stored in the storage means is used when the apparatus is accelerated.
